(19) United States
(12) Patent Application Publication
(10) Pub. No.: US 2021/0394485 A1
(43) Pub. Date: Dec. 23, 2021

(54) PLASTIC FILMS HAVING HIGH OPACITY AND LOW TRANSPARENCY FOR ID DOCUMENTS HAVING A TRANSPARENT WINDOW

(71) Applicant: Covestro Intellectual Property GmbH & Co. KG, Leverkusen (DE)

(72) Inventors: Georgios Tziovaras, Neuss (DE); Heinz Pudleiner, Krefeld (DE); Kira Planken, Goch (DE); Stefan Janke, Brüggen (DE); Christoph Koehler, Duisburg (DE)

(21) Appl. No.: 17/287,674

(22) PCT Filed: Nov. 12, 2019
(86) PCT No.: PCT/EP2019/080909

§ 371 Date: Apr. 22, 2021

(30) Foreign Application Priority Data
Nov. 16, 2018 (EP) 18206653.0
Mar. 22, 2019 (EP) 19164497.0

(51) Int. Cl. B32B 7/023; C08K 3/22; B32B 27/08; B32B 27/20; B32B 3/26; B32B 27/36; B42D 25/351

(52) U.S. Cl. CPC B32B 7/023; C08K 3/22; B32B 27/08; B32B 27/20; B32B 3/266; B32B 27/365; B42D 25/23; C08K 2003/2241; B32B 2307/412; B32B 2307/41; B32B 2554/00; B32B 2307/4026; B32B 2264/1022; B42D 25/351

(57) ABSTRACT

The present invention relates to a layered composite comprising at least one transparent layer a) containing a thermoplastic, this transparent layer having a light transmission in the range of from ≥85% to ≤98% determined according to ISO 13468-2:2006-07, and an opaque layer b) containing at least one thermoplastic, characterised in that the opaque layer b) has a light transmission in the range of from ≥0.1% to ≤25% determined according to ISO 13468-2:2006-07, a layer thickness in the range of from ≥20 μm to ≤70 μm, preferably from ≥20 μm to ≤60 μm, particularly preferably from ≥25 μm to ≤55 μm, and at least one opening.

The present invention relates to multi-layer films comprising thin plastic films having high opacity and low transparency for realization of transparent windows in security documents, preferably identification documents, to a process for producing such multi-layer films and to the security documents comprising such thin plastic films.

For the field of security documents, in particular identification documents, the embedding of a plurality of security features is mandatory, in particular to ensure the originality of these security documents. Such security documents, in particular identification documents, increasingly comprise polycarbonate. Documents based on polycarbonate are particularly durable and exhibit a high level of security against counterfeiting. Popular security features are transparent regions in, for example, identification cards or in data pages of passports. These transparent regions are also known as “windows”. Holograms, security marks and other elements which are identifiable as an original or a counterfeit by visual inspection may be introduced into these windows. The functioning of the security feature is based on the high transparency of polycarbonate. If the transparency of the document in the window is impaired then said document may be a counterfeit. The reasons for this are as follows: When bonding a further transparent film, for example containing false personal information, over the document the change in the window is clearly apparent. The window appears less clear when looking through it. The clarity of the window is likewise disturbed by attempts to open and re-bond the document.

The manufacture of windows in security documents is typically carried out by stamping one or more openings into the opaque white core of the security and/or identification document, as described for example in ID & Secure Document News Vol. 4, July 2016. This white opaque core of the security and/or identification document comprises not only visible security features such as a hologram, security printing or other elements but also further security features, for example electronic components such as antennae and IC chips, which are not visible to the observer on account of the upper white layer. The openings may have any desired shapes but are predominantly circular or elliptical. These openings are filled with a transparent piece of film of identical shape and thickness which is separately stamped from a corresponding film piece. Further transparent films may additionally be arranged on the top or bottom surface of the core. Lamination of such a layer construction affords a monolithic multi-layer film.

The realization of windows is thus very complex and requires a plurality of operating steps in terms of stamping and filling the window with a transparent material. It also requires appropriate filling material in addition to the materials of the individual layers.

The present invention accordingly has for its object to provide a layer construction which allows simple and efficient realization of a so-called window in security documents, preferably identification documents, and also does not impair the incorporation of a plurality of security features in the document, thus making the resulting security document more resistant to counterfeiting.

This object was achieved according to the invention by a multi-layer film comprising at least
a) a transparent layer a) containing a thermoplastic, wherein this transparent layer has a light transmission in the range from ≥85% to ≤98% determined according to ISO 13468-2:2006-07 and
b) an opaque layer b) containing at least one thermoplastic,

characterized in that the opaque layer b) has a light transmission in the range from ≥0.1% to ≤25% determined according to ISO 13468-2:2006-07, a layer thickness in the range from ≥20 μm to ≤70 μm, preferably from ≥20 μm to ≤60 μm, particularly preferably from ≥25 μm to ≤55 μm, and has at least one opening.

The multi-layer film according to the invention is characterized in that the opening in the white opaque layer need no longer be filled with a further filling material. Furthermore, security features may easily be incorporated into the multi-layer film under the layer with the window. Security features in the form of electronic components such as for example antennae or IC chips may easily be applied between layer a) and b) and are therefore invisible to the observer. The window in the multi-layer film according to the invention has no defects and no bubbles in the window region.

In a further embodiment of the invention the multi-layer film may have at least one further transparent layer c) containing a thermoplastic and a light transmission in the range from ≥85% to ≤98% determined according to ISO 13468-2:2006-07, this layer c) is identical or different to layer a) and is arranged such that a layer sequence a) b) c) results in the multi-layer film.

The thermoplastic of the layers a), b) and/or optionally c) may independently of one another be at least one plastic selected from polymers of ethylenically unsaturated monomers and/or polycondensates of bifunctional reactive compounds and/or polyaddition products of bifunctional reactive compounds or mixtures thereof.

Particularly suitable thermoplastics are polycarbonates or copolycarbonates based on diphenols, poly- or copolyacrylates and poly- or copolymethacrylates, for example and preferably polymethyl methacrylate (PMMA), poly- or copolymers with styrene, for example and preferably polystyrene (PS) or polystyrene acrylonitrile (SAN), thermoplastic polyurethanes and polyolefins, for example and preferably polypropylene types or polyolefins based on cyclic olefins (for example TOPAS™), poly- or copolycondensates of an aromatic dicarboxylic acid and aliphatic, cycloalophatic and/or araliphatic diols having 2 to 16 carbon atoms, for example and preferably poly- or copolycondensates of terephthalic acid, particularly preferably poly- or copolyethylene terephthalate (PET or CoPET), glycol-modified PET (PETG), glycol-modified poly- or copolycyclohexanedimethylene terephthalate (PCTG) or poly- or copolybutylene terephthalate (PBT or CoPBT), preferably polyor copolycondensates of naphthalenedicarboxylic acid, particularly preferably polyethylene glycol naphthalate (PEN), poly- or copolycondensate(s) of at least one cycloalkyldicarboxylic acid, for example and preferably polycyclohexanedimethanolcyclohexanedicarboxylic acid (PCCD), polysulfones (PSU), polyvinyl halides, for example and preferably polyvinyl chloride (PVC), or mixtures of the abovementioned.

Particularly preferred thermoplastics are one or more polycarbonate(s) or copolycarbonate(s) based on diphenols or blends containing at least one polycarbonate or copolycarbonate. Very particular preference is given to blends containing at least one polycarbonate or copolycarbonate and at least one poly- or copolycondensate of terephthalic acid, of naphthalenedicarboxylic acid or of a cycloalkyldicarboxylic acid, preferably of cyclohexanedicarboxylic acid. Very particular preference is given to polycarbonates or copolycarbonates, especially having average molecular weights Mw of 500 to 100 000, preferably of 10 000 to 80 000, particularly preferably of 15 000 to 40 000, or blends thereof with at least one poly- or copolycondensate of terephthalic acid having average molecular weights Mw of 10 000 to 200 000, preferably of 21 000 to 120 000.

Suitable poly- or copolycondensates of terephthalic acid in preferred embodiments of the invention are polyalkylene terephthalates. Suitable polyalkylene terephthalates are, for example, reaction products of aromatic dicarboxylic acids or their reactive derivatives (for example dimethyl esters or anhydrides) and aliphatic, cycloaliphatic or araliphatic diols and mixtures of these reaction products.

Preferred polyalkylene terephthalates may be produced from terephthalic acid (or reactive derivatives thereof) and aliphatic or cycloaliphatic diols having 2 to 10 carbon atoms by known methods (Kunststoff-Handbuch, vol. VIII, p. 695 ff, Karl-Hanser-Verlag, Munich 1973).

Preferred polyalkylene terephthalates contain at least 80 mol %, preferably 90 mol %, of terephthalic acid radicals, based on the dicarboxylic acid component, and at least 80 mol %, preferably at least 90 mol %, of ethylene glycol and/or butane-1,4-diol and/or cyclohexane-1,4-dimethanol radicals, based on the diol component.

The preferred polyalkylene terephthalates may contain, in addition to terephthalic acid radicals, up to 20 mol % of radicals of other aromatic dicarboxylic acids having 8 to 14 carbon atoms or of aliphatic dicarboxylic acids having 4 to 12 carbon atoms, such as for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, in addition to ethylene and/or butane-1,4-diol glycol radicals, up to 80 mol % of other aliphatic diols having 3 to 12 carbon atoms or of cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and 2-ethylhexane-1,6-diol, 2,2-diethylpropane-1,3-diol, hexane-2,5-diol, 1,4-di([beta]-hydroxyethoxy)benzene, 2,2-bis(4-hydroxycyclohexyl)propane, 2,4-dihydroxy-1,1,3,3-tetramethylcyclobutane, 2,2-bis(3-[beta]-hydroxyethoxyphenyl)propane and 2,2-bis(4-hydroxypropoxyphenyl)propane (cf. DE-OS 24 07 674, 24 07 776, 27 15 932).

The polyalkylene terephthalates may be branched by incorporation of relatively small amounts of tri- or tetrahydric alcohols or tri- or tetrabasic carboxylic acids, as described for example in DE-OS 19 00 270 and U.S. Pat. No. 3,692,744. Examples of preferred branching agents are trimesic acid, trimellitic acid, trimethylolethane and trimethylolpropane and pentaerythritol.

It is preferable when not more than 1 mol % of the branching agent is used, based on the acid component.

Particular preference is given to polyalkylene terephthalates which have been produced solely from terephthalic acid and the reactive derivatives thereof (e.g. the dialkyl esters thereof) and ethylene glycol and/or butane-1,4-diol and/or cyclohexane-1,4-dimethanol radicals, and to mixtures of these polyalkylene terephthalates.

Preferred polyalkylene terephthalates further include copolyesters produced from at least two of the abovementioned acid components and/or from at least two of the abovementioned alcohol components; particularly preferred copolyesters are poly(ethylene glycol/butane-1,4-diol) terephthalates.

The polyalkylene terephthalates preferably used as component preferably have an intrinsic viscosity of about 0.4 to 1.5 dl/g, preferably 0.5 to 1.3 dl/g, measured in each case in phenol/o-dichlorobenzene (1:1 parts by weight) at 25° C.

In particularly preferred embodiments of the invention the blend of at least one polycarbonate or copolycarbonate with at least one poly- or copolycondensate of terephthalic acid is a blend of at least one polycarbonate or copolycarbonate with poly- or copolybutylene terephthalate or glycol-modified poly- or copolycyclohexanedimethylene terephthalate. Such a blend of polycarbonate or copolycarbonate with poly- or copolybutylene terephthalate or glycol-modified poly- or copolycyclohexanedimethylene terephthalate may preferably be one comprising 1% to 90% by weight of polycarbonate or copolycarbonate and 99% to 10% by weight of poly- or copolybutylene terephthalate or glycol-modified poly- or copolycyclohexanedimethylene terephthalate, preferably comprising 1% to 90% by weight of polycarbonate and 99% to 10% by weight of polybutylene terephthalate or glycol-modified polycyclohexanedimethylene terephthalate, wherein the proportions add up to 100% by weight. Such a blend of polycarbonate or copolycarbonate with poly- or copolybutylene terephthalate or glycol-modified poly- or copolycyclohexanedimethylene terephthalate may particularly preferably be one comprising 20% to 85% by weight of polycarbonate or copolycarbonate and 80% to 15% by weight of poly- or copolybutylene terephthalate or glycol-modified poly- or copolycyclohexanedimethylene terephthalate, preferably comprising 20% to 85% by weight of polycarbonate and 80% to 15% by weight of polybutylene terephthalate or glycol-modified polycyclohexanedimethylene terephthalate, wherein the proportions add up to 100% by weight. Such a blend of polycarbonate or copolycarbonate with poly- or copolybutylene terephthalate or glycol-modified poly- or copolycyclohexanedimethylene terephthalate may very particularly preferably be one comprising 35% to 80% by weight of polycarbonate or copolycarbonate and 65% to 20% by weight of poly- or copolybutylene terephthalate or glycol-modified poly- or copolycyclohexanedimethylene terephthalate, preferably comprising 35% to 80% by weight of polycarbonate and 65% to 20% by weight of polybutylene terephthalate or glycol-modified polycyclohexanedimethylene terephthalate, wherein the proportions add up to 100% by weight. In very particularly preferred embodiments blends of polycarbonate and glycol-modified polycyclohexanedimethylene terephthalate may be concerned in the compositions mentioned above.

Suitable polycarbonates or copolycarbonates in preferred embodiments are particularly aromatic polycarbonates or copolycarbonates.

The polycarbonates or copolycarbonates may be linear or branched in known fashion.

These polycarbonates may be produced in known fashion from diphenols, carbonic acid derivatives, optionally chain terminators and optionally branching agents. Particulars pertaining to the production of polycarbonates are disclosed in many patent documents spanning approximately the last 40 years. Reference is made here merely by way of example to Schnell, “Chemistry and Physics of Polycarbonates”, Polymer Reviews, volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, volume 11, second edition, 1988, pages 648-718 and finally to Dres. U. Grigo, K. Kirchner and P. R. Müller, “Polycarbonate” in Becker/Braun, Kunststoff-Handbuch, volume 3/1, Polycarbonate, Polyacetale, Polyester, Celluloseester, Carl Hanser Verlag Munich, Vienna 1992, pages 117-299.

Suitable diphenols may be, for example, dihydroxyaryl compounds of general formula (I)

HO—Z—OH (I)

wherein Z is an aromatic radical having 6 to 34 carbon atoms which may contain one or more optionally substituted aromatic rings and aliphatic or cycloaliphatic radicals or alkylaryls or heteroatoms as bridging members.

Examples of suitable dihydroxyaryl compounds include: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

These and further suitable other dihydroxyaryl compounds are described, for example, in DE-A 3 832 396, FR-A 1 561 518, in H. Schnell, Chemistry and Physics of Polycarbonates, Interscience Publishers, New York 1964, p. 28 ff.; p. 102 ff., and in D. G. Legrand, J. T. Bendler, Handbook of Polycarbonate Science and Technology, Marcel Dekker New York 2000, p. 72 ff.

Preferred dihydroxyaryl compounds are, for example, resorcinol, 4,4′-dihydroxydiphenyl, bis(4-hydroxyphenyl)methane, bis(3,5-dimethyl-4-hydroxyphenyl)methane, bis(4-hydroxyphenyl)diphenylmethane, 1,1-bis(4-hydroxyphenyl)-1-phenylethane, 1,1-bis(4-hydroxyphenyl)-1-(1-naphthyl)ethane, 1,1-bis(4-hydroxyphenyl)-1-(2-naphthyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)-1-phenylpropane, 2,2-bis(4-hydroxyphenyl)hexafluoropropane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane, 1,1-bis(3,5-dimethyl-4-hydroxyphenyl)cyclohexane, 1,1-bis(4-hydroxyphenyl)-4-methylcyclohexane, 1,3-bis[2-(4-hydroxyphenyl)-2-propyl]benzene, 1,1′-bis(4-hydroxyphenyl)-3-diisopropylbenzene, 1,1′-bis(4-hydroxyphenyl)-4-diisopropylbenzene, 1,3-bis-[2-(3,5-dimethyl-4-hydroxyphenyl)-2-propyl]benzene, bis(4-hydroxyphenyl) ether, bis(4-hydroxyphenyl) sulfide, bis(4-hydroxyphenyl) sulfone,

bis(3,5-dimethyl-4-hydroxyphenyl) sulfone and 2,2′,3,3′-tetrahydro-3,3,3′,3′-tetramethyl-1,1′-spirobi[1H-indene]-5,5′-diol or dihydroxydiphenylcycloalkanes of formula (Ia)

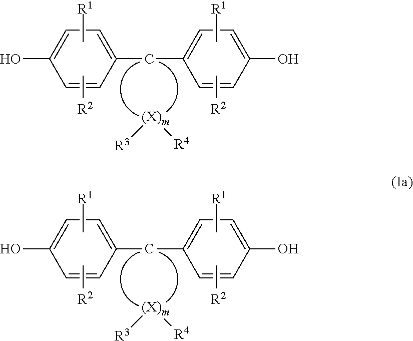

wherein

R¹ and R² independently of one another represent hydrogen, halogen, preferably chlorine or bromine, C₁-C₈-alkyl, C₅-C₆-cycloalkyl, C₆-C₁₀-aryl, preferably phenyl, and C₇-C₁₂-aralkyl, preferably phenyl-C₁-C₄-alkyl, in particular benzyl,

m is an integer from 4 to 7, preferably 4 or 5,

R³ and R⁴ individually selectable for each X independently of one another represent hydrogen or C₁-C₆-alkyl and

X represents carbon,

with the proviso that for at least one atom X, R³ and R⁴ both represent alkyl. It is preferable when in formula (Ia) for one or two atom(s) X, especially only for one atom X, R³ and R⁴ both represent alkyl.

A preferred alkyl radical for the radicals R³ and R⁴ in formula (Ia) is methyl. The X atoms alpha to the diphenyl-substituted carbon atom (C-1) are preferably not dialkyl-substituted but the alkyl disubstitution beta to C-1 is preferred. Particularly preferred dihydroxydiphenylcycloalkanes of formula (Ia) are those having 5 and 6 ring carbon atoms X in the cycloaliphatic radical (m=4 or 5 in formula (Ia)), for example the diphenols of formulae (Ia-1) to (Ia-3),

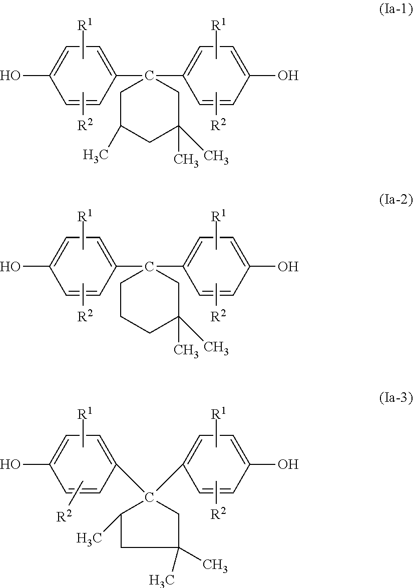

A very particularly preferred dihydroxydiphenylcycloalkane of formula (Ia) is 1,1-bis(4-hydroxyphenyl)-3,3,5-trimethylcyclohexane (formula (Ia-1) where R¹ and R² ═H).

Such polycarbonates may be produced from dihydroxydiphenylcycloalkanes of formula (Ia) according to EP-A 359 953.

Particularly preferred dihydroxyaryl compounds are resorcinol, 4,4′-dihydroxydiphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 4,4′-dihydroxydiphenyl and 2,2-bis(4-hydroxyphenyl)propane.

It is possible to use either one dihydroxyaryl compound to form homopolycarbonates or different dihydroxyaryl compounds to form copolycarbonates. It is possible to use either one dihydroxyaryl compound of formula (I) or (Ia) to form homopolycarbonates or two or more dihydroxyaryl compounds of formula(e) (I) and/or (Ia) to form copolycarbonates. The various dihydroxyaryl compounds may be interconnected in random or blockwise fashion. In the case of copolycarbonates composed of dihydroxyaryl compounds of formulae (I) and (Ia) the molar ratio of dihydroxyaryl compounds of formula (Ia) to the optionally co-usable other dihydroxyaryl compounds of formula (I) is preferably between 99 mol % of (Ia) to 1 mol % of (I) and 2 mol % of (Ia) to 98 mol % of (I), preferably between 99 mol % of (Ia) to 1 mol % of (I) and 10 mol % of (Ia) to 90 mol % of (I), and especially between 99 mol % of (Ia) to 1 mol % of (I) and 30 mol % of (Ia) to 70 mol % of (I).

A very particularly preferred copolycarbonate may be produced using 1,1-bis(4-hydroxyphenyl)-3,3,5-trimethylcyclohexane and 2,2-bis(4-hydroxyphenyl)propane dihydroxyaryl compounds of formulae (Ia) and (I).

Suitable carbonic acid derivatives may be, for example, diaryl carbonates of general formula (II)

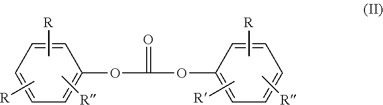

wherein

R, R′ and R″ are identical or different and independently of one another represent hydrogen, linear or branched C₁-C₃₄-alkyl, C₇-C₃₄-alkylaryl or C₆-C₃₄-aryl, R may additionally also be —COO—R′″ where R′″ is hydrogen, linear or branched C₁-C₃₄-alkyl, C₇-C₃₄-alkylaryl or C₆-C₃₄-aryl.

Preferred diaryl carbonates are for example diphenyl carbonate, methylphenyl phenyl carbonates and di(methylphenyl) carbonates, 4-ethylphenyl phenyl carbonate, di(4-ethylphenyl) carbonate, 4-n-propylphenyl phenyl carbonate, di(4-n-propylphenyl) carbonate, 4-isopropylphenyl phenyl carbonate, di(4-isopropylphenyl) carbonate, 4-n-butylphenyl phenyl carbonate, di(4-n-butylphenyl) carbonate, 4-isobutylphenyl phenyl carbonate, di(4-isobutylphenyl) carbonate, 4-tert-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl) carbonate, 4 isooctylphenyl phenyl carbonate, di(4-isooctylphenyl) carbonate, 4-n-nonylphenyl phenyl carbonate, di(4-n-nonylphenyl) carbonate, 4-cyclohexylphenyl phenyl carbonate, di(4-cyclohexylphenyl) carbonate, 4-(1-methyl-1-phenylethyl)phenyl phenyl carbonate, di[4-(1-methyl-1-phenylethyl)phenyl]carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl] carbonate, di[4-(2-naphthyl)phenyl] carbonate, 4-phenoxyphenyl phenyl carbonate, di(4-phenoxyphenyl) carbonate, 3-pentadecylphenyl phenyl carbonate, di(3-pentadecylphenyl) carbonate, 4-tritylphenyl phenyl carbonate, di(4-tritylphenyl) carbonate, (methyl salicylate) phenyl carbonate, di(methyl salicylate) carbonate, (ethyl salicylate) phenyl carbonate, di(ethyl salicylate) carbonate, (n-propyl salicylate) phenyl carbonate, di(n-propyl salicylate) carbonate, (isopropyl salicylate) phenyl carbonate, di(isopropyl salicylate) carbonate, (n-butyl salicylate) phenyl carbonate, di(n-butyl salicylate) carbonate, (isobutyl salicylate) phenyl carbonate, di(isobutyl salicylate) carbonate, (tert-butyl salicylate) phenyl carbonate, di(tert-butyl salicylate) carbonate, di(phenyl salicylate) carbonate and di(benzyl salicylate) carbonate.

Particularly preferred diaryl compounds are diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl] carbonate and di(methyl salicylate) carbonate. Diphenyl carbonate is very particularly preferred.

It is possible to use either one diaryl carbonate or different diaryl carbonates.

To control or alter the end groups it is also possible to employ for example one or more monohydroxyaryl compound(s) not used to produce the diaryl carbonate(s) as chain terminators. These may be selected from compounds of general formula (III)

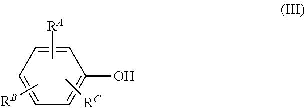

wherein

R^{A} represents linear or branched C₁-C₃₄-alkyl, C₇-C₃₄-alkylaryl, C₆-C₃₄-aryl or —COO—R^{D}, wherein R^{D} represents hydrogen, linear or branched C₁-C₃₄-alkyl, C₇-C₃₄-alkylaryl or C₆-C₃₄-aryl, and

R^{B}, R^{C} are identical or different and independently of one another represent hydrogen, linear or branched C₁-C₃₄-alkyl, C₇-C₃₄-alkylaryl or C₆-C₃₄-aryl.

Such monohydroxyaryl compounds are, for example, 1-, 2- or 3-methylphenol, 2,4-dimethylphenol 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

Preference is given to 4-tert-butylphenol, 4-isooctylphenol and 3-pentadecylphenol.

Suitable branching agents include compounds having three or more functional groups, preferably those having three or more hydroxyl groups.

Suitable compounds having three or more phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol and tetra(4-hydroxyphenyl)methane.

Other suitable compounds having three or more functional groups are, for example, 2,4-dihydroxybenzoic acid, trimesic acid/trimesoyl trichloride, cyanuric trichloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

In a preferred embodiment layer b) according to the invention comprises at least one filler. The filler is preferably at least one color pigment and/or at least one other filler for producing a translucence of the filled layers, particularly preferably a white pigment, very particularly preferably titanium dioxide, zirconium dioxide and/or barium sulfate and in a particularly preferred embodiment titanium dioxide.

The recited fillers are preferably added in amounts of 2% to 50% by weight, particularly preferably of 5% to 40% by weight, based on the total weight of the layer containing the filler which may be produced for example by extrusion or coextrusion.

Layer b) has a light transmission in the range from ≥0.1% to ≤25% determined according to ISO 13468-2:2006-07, a layer thickness in the range from ≥20 μm to ≤70 μm, preferably from ≥20 μm to ≤60 μm, particularly preferably from ≥25 μm to ≤55 μm.

The at least one opening in layer b) may have different shapes and sizes; the opening in layer b) preferably has a circular or elliptical shape.

In another embodiment the opening may also have other shapes such as for example a star shape, a square, a triangle, a rectangle or a combination of at least two of the abovementioned shapes. More complex shapes such as for example a head shape as opening may thus also be realized. In this preferred embodiment of the multi-layer film the opening has a shape selected from the group consisting of star-shaped, square, triangular, rectangular, head-shaped or a combination of at least two thereof.

The opening in layer b) is preferably introduced into layer b) by stamping with a suitable die by methods known to those skilled in the art.

In another preferred embodiment the opening in layer b) may be introduced into layer b) by means of laser radiation. This typically employs a laser having a wavelength in the range from ≥8500 nm to ≤13 000 nm, preferably a CO₂ laser. The multi-layer film is preferred when the opening in layer b) is introduced into layer b) by means of laser radiation, preferably with a wavelength in the range from ≥8500 nm to ≤13 000 nm, preferably using a CO₂ laser.

The use of laser radiation to realize the opening makes it possible to obtain a multiplicity of geometries.

In a further embodiment of the invention the opening in layer b) is not additionally filled with a thermoplastic material.

In a further embodiment layer a), b) and/or c) may contain a laser-sensitive additive, preferably a black pigment, particularly preferably carbon black. This embodiment of the invention is particularly readily amenable to laser gravure. The marking of plastic films by laser gravure is referred to as laser marking for short both in the art and hereinbelow. Accordingly the term “laser marked” is hereinbelow to be understood as meaning marked by laser gravure. The process of laser gravure is known to those skilled in the art and is not to be confused with printing using laser printers.

The laser-sensitive additive may be present in the film according to the invention in an amount of ≥3 to ≤200 ppm, preferably of ≥40 to ≤180 ppm, particularly preferably of ≥50 to ≤160 ppm.

The particle size of the laser-sensitive additive is preferably in the range from 100 nm to 10 μm and particularly advantageously in the range from 50 nm to 2 μm.

The layer thickness of layer a) may be in a range from ≥30 to ≤800 μm, preferably ≥35 to ≤700 μm, particularly preferably ≥40 to ≤600 μm.

The layer thickness of layer c) may be in a range from ≥30 to ≤700 μm, preferably ≥35 to ≤400 μm, particularly preferably ≥40 to ≤130 μm.

The multi-layer film may comprise further layers of a thermoplastic as described hereinabove.

The layers a), b), c) and/or optionally further layers are preferably films, in particular mono- and/or multilayer films, producible by extrusion or coextrusion and comprising the abovementioned thermoplastics.

The layer thickness of layer a) may be achieved either by a single film of the corresponding layer thickness or by lamination of several thin films a).

In one embodiment layer a) may form a middle layer of the multi-layer film and layers b), c) and optionally further layers are attached symmetrically on both sides in the multi-layer film.

One or more security features may be introduced at any desired locations in the multi-layer film according to the invention. Security features can be introduced into the multi-layer film as electronic components, for example antennae and IC chips, holograms and/or security marks. Ideally one or more security features are placed in the layer construction according to the invention such that they are at least partially covered by layer b). Placing one or more security features between layers a) and b) would be conceivable for example. However, further security features may also be present at other locations in the multi-layer film according to the invention. Ideally one security feature is placed such that it is visible through the window.

The individual layers of the multi-layer film may be compressed for a particular duration by lamination using a laminating press under the action of heat and pressure to form a monolithic composite of the individual layers, a so-called laminate. The pressure and temperature during the laminating operation are to be selected such that the individual layers and the optionally present security features are not damaged but the individual layers form a strong composite which does not subsequently break up into its individual layers.

The invention further provides a process for producing a multi-layer film comprising
providing at least one layer construction comprising at least one transparent layer a) containing a thermoplastic, wherein this transparent layer has a light transmission in the range from ≥85% to ≤98% determined according to ISO 13468-2:2006-07, and an opaque layer b) containing at least one thermoplastic, characterized in that the opaque layer b) has a light transmission in the range from ≥0.1% to ≤25% determined according to ISO 13468-2:2006-07, a layer thickness in the range from ≥20 μm to ≤70 μm, preferably from ≥20 μm to ≤60 μm, particularly preferably from ≥25 μm to ≤55 μm, and at least one opening and optionally a layer c) containing a thermoplastic and a light transmission in the range from ≥85% to ≤98% determined according to ISO 13468-2:2006-07, wherein this layer c) is identical or different to layer a) and is arranged such that a layer sequence a) b) c) results in the multi-layer film,
optionally providing further layers comprising at least one thermoplastic,
optionally applying security features in such a way that layer b) at least partially covers these security features,
laminating the layer construction at a temperature of 120° C. to 210° C., preferably of 130° C. to 205° C., particularly preferably of 150° C. to 200° C., and a pressure of 10 N/cm² to 400 N/cm², preferably of 30 N/cm² to 300 N/cm², particularly preferably of 40 N/cm² to 250 N/cm².

In a preferred embodiment of the process according to the invention the opening in layer b) is introduced into layer b) by means of laser radiation, preferably with a wavelength in the range from ≥8500 nm to ≤13 000 nm, preferably using a CO2 laser.

For the avoidance of repetition reference is made to what is recited above in respect of the embodiments and preferred ranges of the individual layers.

In another embodiment of the process according to the invention the layer construction may be inscribed by means of laser radiation before and/or after lamination.

The invention further provides a security document, preferably identification document, comprising at least one layer construction according to the invention as described hereinabove.

The invention further provides for the use of an opaque layer comprising at least one thermoplastic, which has a light transmission in the range from ≥0.1% to ≤25% determined according to ISO 13468-2:2006-07, a layer thickness in the range from ≥20 μm to ≤70 μm, preferably from ≥20 μm to ≤60 μm, particularly preferably from ≥25 μm to ≤55 μm, for producing windows in security documents. To avoid repetition reference is made to the foregoing in respect of embodiments and preferred ranges of the opaque layer.

### EXAMPLES

Raw Materials Employed:

Makrolon™ 3108: high-viscosity, amorphous thermoplastic bisphenol A polycarbonate having an MVR of 6 g/10 min according to ISO 1133-1:2011 at 300° C. and 1.2 kg of applied weight from Covestro AG.

KRONOS™ 2230: titanium dioxide from Kronos for polycarbonate and other industrial thermoplastics having a TiO₂ content ≥96%

### Example 1: Compounding a Masterbatch for Production of the Layer Containing a Thermoplastic and a White Pigment as Filler

Production of the masterbatch for production of a white layer was carried out with a conventional twin-screw compounding extruder (ZSK 32) at processing temperatures customary for polycarbonate of 250° C. to 330° C.

A masterbatch having the following composition was compounded and subsequently granulated:
70% by weight of Makrolon™ 3108 polycarbonate
30% by weight of Kronos™ 2230 (titanium dioxide) as white pigment filler.

General Production Procedure for Extrusion Films

The employed apparatus consists of
an extruder having a screw of 105 mm in diameter (D) and a length of 41×D. The screw has a devolatilization zone;
a crosshead;
a slot die of 1500 mm in width;
a three-roll smoothing calendar with horizontal roller orientation, wherein the third roller can swivel by +/−45° relative to the horizontal;
a roller conveyor;
an apparatus for double-sided application of protective film;
a haul-off apparatus;
a winding station.

The pellet material was supplied to the extruder hopper. The respective material was melted and conveyed in the respective barrel/screw plasticizing system. The material melt was supplied to the nozzle. The melt passed from the nozzle onto the smoothing calendar. On the smoothing calendar the material is subjected to final shaping and cooling. Structuring of the film surfaces was achieved using a matted steel roller (no. 4 surface) and a matted rubber roller (no. 4 surface). The film was subsequently transported through a haul-off and then the film was wound up. The corresponding white opaque extrusion films were produced in this way according to table 1.

TABLE 1
White opaque films

| | Compound | Layer thickness |
|---|---|---|
| Example 2 | 100% compound from example 1 | 30 μm |
| Example 3 | 50% compound from example 1; | 30 μm |
| (noninventive) | 50% Makrolon ™ 3108 | |
| Example 4 | 100% compound from example 1 | 50 μm |
| Example 5 | 50% compound from example 1 + | 100 μm |
| (noninventive) | 50% Makrolon ™ 3108 | |

Light Transmission and Breaking Elongation of the White Opaque Films

Thin films are particularly sensitive to agglomerates, i.e. non-homogeneously distributed titanium dioxide. The dispersion of the titanium dioxide in the film and the homogeneity of the film thickness were assessed visually and the light transmission of the films determined. The dispersion of the titanium dioxide in the film and the mechanical strength may further be assessed by determining breaking elongation.

Light transmission was determined according to ISO 13468-2:2006-07 using a Byk Haze Gard Plus measuring instrument. Tensile tests were performed according to ISO 527-1:1996. The tensile rod type employed was ISO 527-1:1996 type 1B.

TABLE 2
Light transmission and breaking elongation of the white
opaque films

| | Light transmission | Breaking elongation |
|---|---|---|
| Film | % | DR % |
| Example 2 | 9.5 | 60.9 |
| Example 3 | 34.3 | not determined |
| (noninventive) | | |
| Example 4 | 8.5 | 101.8 |
| Example 5 | 8.8 | not determined |
| (noninventive) | | |

Production of Identification Documents (ID Card) Having Transparent Window

Films for the Layer Construction:

Films of Examples 2-5

Example 6: A polycarbonate film of 100 μm in thickness was produced as described hereinabove from Makrolon™ 3108 polycarbonate by extrusion at a melt temperature of about 280° C. Structuring of the film surfaces was achieved using a matted steel roller (no. 6 surface) and a matted rubber roller (no. 2 surface).

Example 7: A film as per film 6 was produced but with a thickness of 540 μm.

Stamped into each of the white opaque films was a hole of 10 mm in diameter and, next to it, a second hole of 20 mm in diameter.

Layer constructions according to table 3 were produced. A symmetrical layer construction of the card was selected to avoid bending of the card. To this end, respective stacks were formed from the films in the orders shown in table 3 and lamination was carried out with the following parameters on a Bürkle lamination press.

Conditions
Preheating the press to 170-180° C.
pressing for 8 minutes at a pressure of 15 N/cm²
pressing for 2 minutes at a pressure of 200 N/cm²
cooling the press to 38° C. and opening the press.

TABLE 3
Layer construction of the ID cards having a transparent window

| | Layer (1) | Layer (2) | Layer (3) | Layer (2) | Layer (1) |
|---|---|---|---|---|---|
| Exam- | Example 6 | Example 2 | Example 7 | Example 2 | Example 6 |
| ple 8 | (100 μm) | (30 μm) | (540 μm) | (30 μm) | 100 μm |
| Exam- | Example 6 | Example 3* | Example 7 | Example 3* | Example 6 |
| ple 9 * | (100 μm) | (30 μm) | (540 μm) | (30 μm) | (100 μm) |
| Exam- | Example 6 | Example 4 | Example 7 | Example 4 | Example 6 |
| ple 10 | (100 μm) | (50 μm) | (540 μm) | (50 μm) | (100 μm) |
| Exam- | Example 6 | Example 5* | Example 7 | Example 5* | Example 6 |
| ple 11* | (100 μm) | (100 μm) | (540 μm) | (100 μm) | (100 μm) |

* noninventive

The openings in the films of the layers (2) were each arranged symmetrically in the film stack.

Results of the Laminations

For all cards opacity was assessed visually and the stamping of the round transparent window was assessed for air bubbles and sink marks.

In noninventive example 11 a sink mark in the region of the transparent window and also an air bubble were apparent. This defect was avoidable only by inserting a transparent filler material prior to lamination. This results in increased complexity in the production of ID documents.

Both laminates of examples 8 and 10 according to the invention exhibited no sink marks and no bubble formation and so flawless laminate quality was obtainable. In addition, light transmission was very low due to the high opacity of the films. To the extent that printed images, antennae or IC chips are incorporated into the layer construction these are not apparent in the laminates according to the invention.

No sink marks and no bubble formation were observable in noninventive example 9 but the laminate from example 9 had a high light transmission. As a result of the high light transmission, printed images, antennae or IC chips may therefore be apparent to the extent these are incorporated into the layer construction.

1. A multi-layer film comprising at least
a) a transparent layer a) containing a thermoplastic, wherein the transparent layer has a light transmission in a range from ≥85% to ≤98% determined according to ISO 13468-2:2006-07; and
b) an opaque layer b) containing at least one thermoplastic,
wherein the opaque layer b) has a light transmission in a range from ≥0.1% to ≤25% determined according to ISO 13468-2:2006-07, a layer thickness in a range from ≥20 μm to ≤70 μm, and has at least one opening.

2. The multi-layer film as claimed in claim 1, further comprising at least one further transparent layer c) containing a thermoplastic and having a light transmission in a range from ≥85% to ≤98% determined according to ISO 13468-2:2006-07, wherein the layer c) is identical to or different from layer a) and is arranged such that a layer sequence a) b) c) results in the multi-layer film.

3. The multi-layer film as claimed in claim 1, wherein layer b) contains at least one filler.

4. The multi-layer film as claimed in claim 1, wherein layers a), layer b) optionally a further transparent layer c), or a combination thereof independently of one another comprise at least one thermoplastic selected from the group consisting of a polymer of ethylenically unsaturated monomers a polycondensates of bifunctional reactive compounds, and combinations thereof.

5. The multi-layer film as claimed in claim 1, wherein the at least one opening in layer b) is not additionally filled with a thermoplastic material.

6. The multi-layer film as claimed in claim 1, wherein layer a), layer b), optionally a further transparent layer c), or a combination thereof comprises a laser-sensitive additive.

7. The multi-layer film as claimed in claim 1, wherein the layer a) has a thickness of ≥30 to ≤800 μm.

8. The multi-layer film as claimed in claim 2, wherein the at least one layer c) has a thickness of ≥30 to ≤700 μm.

9. The multi-layer film as claimed in claim 1, wherein the opening has a shape selected from the group consisting of star-shaped, square, triangular, rectangular, head-shaped, and a combination of at least two thereof.

10. The multi-layer film as claimed in claim 1, wherein the opening in layer b) is introduced into layer b) by means of laser radiation.

11. A process for producing a multi-layer film comprising
providing at least one multi-layer film construction as claimed in claim 1,
optionally providing further layers comprising at least one thermoplastic,
optionally applying security features in such a way that layer b) at least partially covers these security features,
laminating the multi-layer film construction at a temperature of 120° C. to 210° C. ° C. to and a pressure of 10 N/cm² to 400 N/cm².

12. The process as claimed in claim 11, wherein the multi-layer film construction is inscribed by laser radiation before and/or after lamination.

13. The process as claimed in claim 11, wherein the opening in layer b) is introduced into layer b) by laser radiation.

14. A security document, comprising at least one multi-layer film construction as claimed in claim 1.

15. A method of producing a window in a security document, comprising preparing a security document comprising an opaque layer comprising at least one thermoplastic, said opaque layer having a light transmission in a range from ≥0.1% to ≤25% determined according to ISO 13468-2:2006-07 and having a layer thickness in a range from ≥20 μm to ≤70 μm.

16. The multi-layer film as claimed in claim 4, wherein the at least one thermoplastic is selected from the group consisting of: one or more polycarbonates or copolycarbonates based on diphenols, poly- or copolyacrylates and poly- or copolymethacrylates, poly- or copolymers of styrene, polyurethanes, polyolefins, poly- or copolycondensates of terephthalic acid, poly- or copolycondensates of naphthalenedicarboxylic acid, poly- or copolycondensates of at least one cycloalkyldicarboxylic acid, polysulfones, and mixtures thereof.

17. The multi-layer film as claimed in claim 4, wherein the at least one thermoplastic is selected from the group consisting of: one or more polycarbonates or copolycarbonates based on diphenols, blends containing at least one polycarbonate, and copolycarbonate.
